(19) United States
(12) Patent Application Publication
(10) Pub. No.: US 2016/0098751 A1
(43) Pub. Date: Apr. 7, 2016

(54) Systems and Methods for Dominant Attribute Analysis

(71) Applicant: Criteo SA, Paris (FR)

(72) Inventors: Stephen John Zimmerman, JR., Los Angeles, CA (US); Behzad Zamanzadeh, Tarzana, CA (US); Alissa Volosin, Paris (FR); Amanda Plummer, Sherman Oaks, CA (US); Swaranjit Dua, Paris (FR)

(21) Appl. No.: 14/875,366

(22) Filed: Oct. 5, 2015

Related U.S. Application Data
(60) Provisional application No. 62/059,646, filed on Oct. 3, 2014.

(51) Int. Cl. G06Q 30/02

(52) U.S. Cl. CPC G06Q 30/0256; G06Q 30/0276

(57) ABSTRACT

Systems and methods for generating and enhancing advertising campaigns and web content using dominant attribute analysis in accordance with embodiments of the invention are disclosed. In one embodiments, a product advertising server system includes a processor and a memory connected to the processor and storing a product advertisement generation application, wherein the product enhancement generation application directs the processor to obtain product feed data, determine category data based on the obtained product feed data, identify dominant attribute data based on the category data, generate a set of product title data based on the dominate attribute data and the product feed data, and store the generated product title data using the memory.

### CROSS-REFERENCE TO RELATED APPLICATIONS

The current application claims priority to U.S. Provisional Patent Application Ser. No. 62/059,646, filed Oct. 3, 2014, the disclosure of which is hereby incorporated by reference in its entirety.

### FIELD OF THE INVENTION

The present invention relates to content generation and more specifically to the creation of product advertising campaigns and website content.

### BACKGROUND

The term e-commerce is used to refer to the buying and selling of products or services over electronic systems such as the Internet and other computer networks. The amount of trade conducted via e-commerce has grown extraordinarily with widespread Internet usage. As a result, a variety of websites have been established to offer goods and services.

Search engines are useful tools for locating specific pages of information on the World Wide Web and are increasingly used to locate goods and services. As a result, many websites use search advertising/search engine marketing to attract visitors to product, service, and/or category landing pages. Search advertising describes the placement of online advertisements adjacent or amongst the search results returned by a search engine in response to a specific search query. Search engine marketing typically involves paying for a specific online advertisement or creative to be featured in or adjacent to the search results provided in response to a specific query. Typically, the position of an advertisement within the returned search results is a function of the bid scaled by a quality factor that measures the relevance of the creative and landing page combination to the search query. Accordingly, the provider of the search engine is incentivized to feature relevant keyword/advertisement/landing page combinations so that users will select featured advertisements and increase the revenue generated by the search engine provider. In the context of paid search advertising, the term keyword refers to both a single word and a specific combination of words or keyword components.

When a website includes a large number of products or services, the process of building and managing a paid search advertising campaign can be quite complex. Many search engines provide the ability to upload an entire advertising campaign including one or more creatives that target a set of keywords, and associated bids to be used when the display of the creative is triggered by specific keywords. For example, Google, Inc. of Mountain View, Calif., defines an Ad Group file format that enables advertisers to upload paid search advertising campaigns.

### SUMMARY OF THE INVENTION

Systems and methods for generating and enhancing advertising campaigns and web content using dominant attribute analysis in accordance with embodiments of the invention are disclosed. In one embodiments, a product advertising server system includes a processor and a memory connected to the processor and storing a product advertisement generation application, wherein the product enhancement generation application directs the processor to obtain product feed data, determine category data based on the obtained product feed data, identify dominant attribute data based on the category data, generate a set of product title data based on the dominate attribute data and the product feed data, and store the generated product title data using the memory.

In another embodiment of the invention, the product enhancement generation application further directs the processor to generate a set of advertising creatives based on the generated product title data and the product feed data, generate a product advertising campaign including the set of advertising creatives, and transmit the product advertising campaign to a search engine provider.

### BRIEF DESCRIPTION OF THE DRAWINGS

FIG. 1 is a conceptual illustration of a product advertising system in accordance with an embodiment of the invention.

FIG. 2 is a conceptual illustration of a product advertising server system in accordance with an embodiment of the invention.

FIG. 3 is a flow chart illustrating a process for creating a product advertising campaign in accordance with an embodiment of the invention.

FIG. 4 is a flow chart illustrating a process for generating product titles based on dominant attributes in accordance with an embodiment of the invention.

FIG. 5 is a flow chart illustrating a process for generating product titles with missing dominant attributes in accordance with an embodiment of the invention.

FIG. 6 is a flow chart illustrating a process for generating product title templates in accordance with an embodiment of the invention.

FIG. 7 is a flow chart illustrating a process for determining dominant attributes in accordance with an embodiment of the invention.

### DETAILED DESCRIPTION

Turning now to the drawings, systems and methods for creating product advertising campaigns and website content in accordance with embodiments of the invention are disclosed. In a variety of product advertising campaigns, advertisements presented to users (e.g. the advertising creative) includes an image and a title (or any other tagline) describing the product. As such, it is extremely important to have titles that clearly describe the attributes of the product in a way that users will be encouraged to engage with the presented advertisement. In many embodiments, a product advertising campaign is generated for a set of products described in a product data feed. The product data feed can contain a variety of information, such as keywords describing the products and/or categories of products, images illustrating the products, references to landing pages containing more information about the products, and any other data that is relevant to the products being advertised as appropriate to the requirements of specific applications of embodiments of the invention. Product advertisement systems in accordance with embodiments of the invention can identify the most relevant attributes (i.e. dominant attributes) for the products being advertised and utilize those attributes in generating the product titles. In this way, the product advertising campaigns generated in accordance with embodiments of the invention are designed to have product titles that are expected to perform well based on historical performance data aggregated across a variety of advertising campaigns. In a variety of embodiments, the dominant attributes can be based on the category (or sub-category) of the product being advertised. In several embodiments, the product data feed may not include attributes corresponding to the identified dominant attributes and the product advertising server system can request additional product data and/or infer additional from the categories and attributes present in a taxonomy. Dominant attributes can be determined (and/or refined) from a variety of raw data (e.g. training data), such as search queries, product data, web content, and any other documents as appropriate to the requirements of specific applications of the invention. It should be noted that the dominant attributes can be global and/or specific to different advertising channels and/or specific product advertisements as appropriate to the requirements of specific applications of embodiments of the invention.

In many embodiments, generating a product advertising campaign utilizes a taxonomy. The term taxonomy is used to describe a particular scheme for classifying products and/or services. Collectively products and/or services (indeed any object, person, idea, or action) can be referred to as a concept and, in many embodiments, concepts can be defined in terms of categories and attribute value pairs. In this way, a taxonomy used to build product advertising campaigns can also include elements of a taxonomy and/or an ontology in the sense that the possible attributes of classified concepts and groupings of concepts can also be specified, as can the relationships (including hierarchical relationships) between those attributes. The taxonomy can also be used to identify relationships between keyword components and the categories and attributes within the taxonomy and these relationships used to identify potentially relevant attributes for use in creating product targets within a product advertising campaign, such as name patterns (e.g. how a product name is displayed) and phrase patterns (e.g. how the details of a product are displayed). In several embodiments, a taxonomy includes categories, attributes, and/or keywords used in a variety of search queries. The taxonomy can also be constructed based on the categories and attributes associated with any of a variety of advertising campaigns and/or product data feeds. In this way, the taxonomy can identify relationships between keywords that can be globally utilized across advertising campaigns. Furthermore, the taxonomy can include performance information related to the categories, attributes, and/or keywords. This performance information can be based on any metric relevant to the requirements of specific applications in accordance with embodiments of the invention, such as, but not limited to, impressions of and/or engagement with particular categories, attributes, and/or keywords.

A product target and associated product data can be combined to form the specific product advertisement that is displayed as part of the search engine results. The product advertisement is designed to direct users to a landing page affiliated with the product target and/or the product data. Different products can be displayed with respect to the same landing page in response to different search queries. Product advertising server systems can generate product advertising campaigns including a plurality of product targets based on a product data feed containing one or more products, where a product can be defined as a set of attribute-value (e.g. attribute-keyword) pairs. Products can be grouped into one or more groups of products based on the attributes and values associated with each of the products. In a variety of embodiments, a product advertising campaign includes a set of categories and attributes along with associations with particular search queries, i.e. keywords provided by a user searching for a particular good and/or service. The product advertising campaign can be transmitted to any third party, such as a search engine provider, an online social network, or any other content provider. Additionally, categories and/or attributes for a particular product (or advertising campaign) can be inferred based on the categories, attributes, and/or values within the taxonomy and the inferred data can then be utilized to generate the product titles. As described in more detail below, these inferred attributes can be utilized to generate advertising campaigns that utilize categories and/or attributes not present in a product data feed describing a set of products. In this way, effective or optimal product targets can be automatically generated based upon the attributes of products and product targets that are likely to perform well with respect to specific queries targeted by the product advertising campaign. Users can then interact with the advertising creative and be presented with product information provided at the landing page described in the product advertisement. Performance data describing the display and engagement with the advertisements can be measures and associated with the categories, attributes, and/or keywords present in the displayed advertisements. This performance data can then be utilized in the determination of dominant attributes.

In a variety of embodiments, product listing advertising involves the presentation of product advertising campaigns designed to advertise one or more products identified as relevant to keywords in a search query alongside the search results presented by a search engine provider in response to the search query. Product advertising campaigns in accordance with embodiments of the invention can include a plurality of product advertisements that contain sets of information or structured data describing one or more products and/or services that are the subject(s) of the product advertising campaign along with product targets that group the product advertisements. Product advertising server systems in accordance with embodiments of the invention can generate product advertisements containing sets of information or structured data that are targeted toward keywords and/or phrases (and/or the intent described by the keywords and/or phrases) contained in search queries provided to a search engine provider. The information and/or structured data in the product advertisements can be utilized by a search engine provider to generate an advertisement based on the product data in the product data feed. In many embodiments, advertisements includes text describing the product in the product advertisement as displayed alongside the search results. In many embodiments, the search engine provider can utilize the provided keywords and/or categories to generate advertising creatives that can be displayed alongside the search results provided in response to the search query. In a number of embodiments, the product advertising campaign includes images, product titles, price information, and/or landing page references (e.g. uniform resource locators (URLs)) that are utilized by the search engine provider to generate the advertising creative. It should be noted that while in a variety of embodiments product titles can be generated from scratch, in many embodiments existing product titles can be augmented (i.e. enhanced) utilizing techniques similar to those described herein. For example, existing product advertising campaigns can be improved by analyzing existing product title and modifying the titles based on dominant attributes present (and/or absent) from the product titles. Additionally, existing web pages and structured data associated with the products can be improved by analyzing the web page content and adding missing attributes using dominant attributes. In a variety of embodiments, web content includes any data associated with a web page including, but not limited to, image data, audio data, text data, video data, and script data. The web content can be presented via any number of platforms, including web sites, mobile sites, partner networks, online catalogs, or any other techniques as appropriate to the requirements of specific applications of the invention. Furthermore, the web content can be associated with some or all of the products described in the product data feed.

Although much of the discussion that follows relates to product advertising campaigns, similar systems and methods in accordance with embodiments of the invention can be used to generate targets in product listing advertising campaigns can also be utilized to generate product data streams. Product data streams (e.g. product data feeds) can contain attribute-value pairs describing products and/or services. In many embodiments, the product data stream describes the products that are being advertised within the product listing advertising campaign. Furthermore, while advertising campaigns are often referred to with respect to products, services and any other subjects of advertising campaigns can be utilized in accordance with embodiments of the invention. Systems and methods for generating and/or updating product advertising campaigns in accordance with embodiments of the invention are discussed below.

### Product Advertising Systems

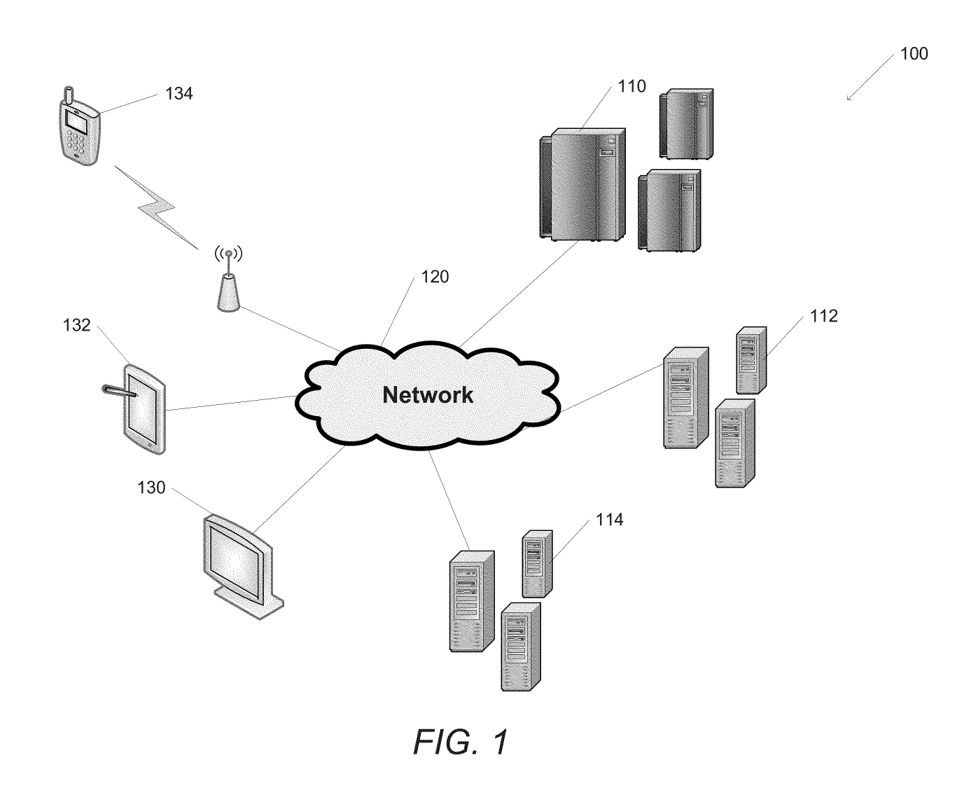

Product advertising systems can generate and deliver product advertisements to user devices alongside search results provided in response to received search queries. Product advertising server systems in accordance with many embodiments of the invention can create product advertising campaigns using product targets targeted toward the search terms used to search for the products and/or services that are related to the products advertised in the product advertising campaign and deploy product advertising campaigns. A conceptual diagram of a product advertising system in accordance with an embodiment of the invention is shown in FIG. 1. The product advertising system 100 includes a product advertising server system 110, a search engine provider 112, a product data server system 114, and user devices including computers 130, tablets 132, and mobile phones 134 capable of communicating via a network 120. In a variety of embodiments, the network 120 is the Internet. In a number of embodiments, the advertising server system 110 and/or product data server system 114 is implemented using a single server system. In several embodiments, the advertising server system 110 and/or product data server system 114 is implemented using multiple server systems.

The product advertising server system 110 can create product advertising campaigns based on a product data feed including one or more pieces of product data and one or more taxonomies describing schemes for categorizing the product data. In a variety of embodiments, the product data feed is obtained from the product data server system 114. In a number of embodiments, the product advertising server system 110 and the product data server system 114 are a single system. In many embodiments, the product advertising server system 110 can determine a set of dominant attributes for one or more of the products described in the product data feed and generate product titles that include keywords corresponding to the identified dominant attributes. In many embodiments, the product advertising campaigns are organized into product groups, where a product group has one or more product targets and product data associated with the product targets. In a variety of embodiments, the product advertising server system 110 can obtain raw data (e.g. training data) that can be utilized to determine dominant attributes.

In several embodiments, the product advertising server system 110 can provide the product advertising campaign to the search engine provider 112. The search engine provider 112 can present product advertisements to the user devices based on keywords and/or phrases contained in search queries provided by the user devices to the search engine provider 112. In many embodiments, the product advertising campaign includes the advertising creative presented to the users by the search engine provider. In a number of embodiments, the search engine provider 112 can generate the advertising creative presented to the user based on the product advertising campaign. Additionally, the search engine provider can provide performance information, such as but not limited to the number of times an advertisement is displayed, engagement with the advertisement, and/or conversions associated with the advertisement, to the product advertising server system 110. In a variety of embodiments, the product advertising server system 110 can associate performance information with the categories and/or attributes within the taxonomy. In this way, the product advertising server system 110 can utilize the performance information in the determination of dominant attributes and the generation of product advertising campaigns. Performance information can also be provided by the product data server system 114 as appropriate to the requirements of specific applications of the invention.

Although a specific architecture of a product advertising system in accordance with embodiments of the invention are discussed above and illustrated in FIG. 1, a variety of architectures, including user devices not specifically named and other methods of serving product advertising campaign information to user devices, can be utilized in accordance with embodiments of the invention. Additionally, while the above is described with respect to search engine providers, any content provider that provides advertisements to users, either alone or alongside content provided by the content provider, can be utilized as appropriate to the requirements of specific applications of embodiments of the invention. Furthermore, it should be noted that any data created and/or transferred within the system can be provided by any system in any manner (i.e. via one or more application programming interfaces (APIs) web services, and/or file-based interfaces not specifically described herein) as appropriate to the requirements of specific applications of embodiments of the invention. Systems and methods for generating product titles and creating product advertising campaigns are discussed below.

### Product Advertising Server Systems

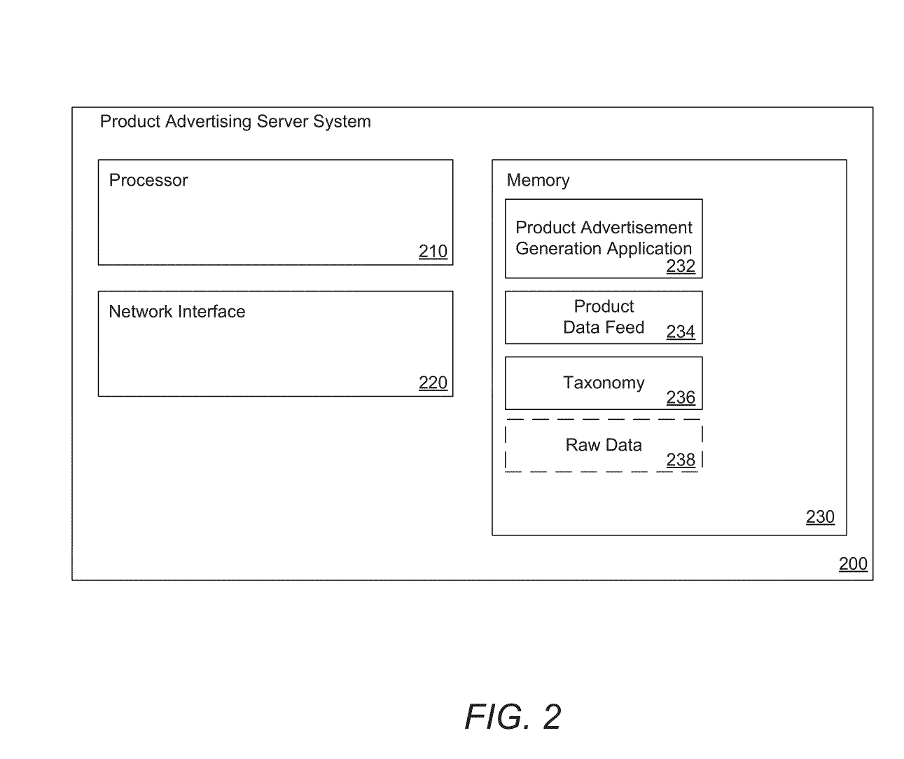

Product advertising server systems in accordance with embodiments of the invention can generate advertisements (e.g. product targets) including product titles used to advertise product data in a product advertising campaign. A conceptual illustration of a product advertising server system in accordance with an embodiment of the invention is shown in FIG. 2. The product advertising server system 200 includes a processor 210 in communication with memory 230. The product advertising server system 200 also includes a network interface 220 capable of sending and receiving data over a network connection. In a number of embodiments, the network interface 220 is in communication with the processor 210 and/or the memory 230. In several embodiments, the memory 230 is any form of storage capable of storing a variety of data, including, but not limited to, a product advertisement generation application 232, a product data feed 234, a taxonomy 236, and/or raw data 238. In many embodiments, the advertising product data generation application 232, performance data 234, a taxonomy 236, and/or raw data 238 are stored using an external server system and received by the product advertising server system 200 using the network interface 220.

The processor 210 is directed by the product advertisement generation application 232 to perform a variety of product advertisement generation processes. These processes include obtaining one or more product data feeds 234, where a product data feeds includes categories, attributes, keywords, images, and/or references to landing pages describing one or more products. Any other data describing the products can be included in a product data feed as appropriate to the requirements of specific applications in accordance with embodiments of the invention. The product advertisement generation processes can also include identifying categories (and/or sub-categories) corresponding to the products data feeds utilizing the taxonomy 236. Advertisement generation processes further include identifying dominant attributes for the products described in the product data feed and utilizing those dominant attributes in the generation of titles. The titles can be utilized in the generation of one or more product advertising campaigns that can be transmitted to a search engine (or any other content) provider. In a variety of embodiments, the product data feed does not include keywords corresponding to the identified dominant attributes. The product advertisement generation processes can include requesting additional product information corresponding to the missing attributes and/or utilizing categories and/or attributes within the taxonomy 236 in order to infer attributes to be utilized in the generation of the product targets.

In many embodiments, product advertisement generation processes include determining one or more dominant attributes based on raw data 238 (i.e. training data). Raw data 238 can include, but is not limited to, categories, attributes, keywords, and/or performance data for those keywords. Time data describing the categories, attributes, keywords, and/or performance data can also be included in the raw data 238. In a variety of embodiments, the time data is utilized to aggregate the categories, attributes, keywords, and/or performance data. Techniques for determining dominant attributes in accordance with embodiments of the invention are described in more detail below.

Although a specific architecture for a product advertising server system in accordance with an embodiment of the invention is conceptually illustrated in FIG. 2, any of a variety of architectures, including those which store data or applications on disk or some other form of storage and are loaded into memory at runtime and systems that are distributed across multiple physical servers, can also be utilized in accordance with embodiments of the invention. In a variety of embodiments, the memory 230 includes circuitry such as, but not limited to, memory cells constructed using transistors, that can store instructions. Similarly, the processor 210 can include logic gates formed from transistors (or any other device) that dynamically perform actions based on the instructions stored in the memory. In several embodiments, the instructions are embodied in a configuration of logic gates within the processor to implement and/or perform actions described by the instructions. In this way, the systems and methods described herein can be performed utilizing both general-purpose computing hardware and by single-purpose devices. Processes for generating titles and creating product advertising campaigns in accordance with embodiments of the invention are discussed below.

### Creating Product Advertising Campaigns

As described above, product advertising server systems in accordance with embodiments of the invention generate and/or update product advertising campaigns for a set of products. In a variety of embodiments, the products that are the subject of the product advertising campaign are described in a product data feed. The product data feed can be obtained from any of a variety of sources, such as product data server systems, retailers, and/or any other entity as appropriate to the requirements of specific applications of the invention. In many embodiments, category information for one or more of the products described in the product data feed is determined. The category information can be determined in any of a variety of ways, including but not limited to utilizing attributes and/or keywords present in the product data feed describing the product to identify one or more categories within a taxonomy based on the categories, attributes, and/or keywords present within the taxonomy. The taxonomy can also be utilized to determine dominant attributes for the attributes and keywords associated with the products. In a number of embodiments, dominant attributes are determined based on historical performance data associated with the attributes. In several embodiments, the performance data is based on both the attributes themselves and the categories associated with the attributes. In this way, the performance of a particular attribute can be tracked (and potentially vary) depending on the category. A variety of information can be associated with the categories and/or attributes within the taxonomy in accordance with the requirements of specific applications of the invention, including, but not limited to, previous advertising campaigns, total clicks, total impressions, top categories (i.e. the category associated with the products that has the best performance), clicks and/or impressions associated with the top category, attributes associated with the top category, and the number of times the attributes associated with the top category were utilized in advertising campaigns. Additional information, such as coverage data describing the number of attributes and keywords present in the product data feed appear within the taxonomy and measures of performance data related to the coverage data, can be utilized to determine confidence scores describing the likelihood that the dominant attributes accurately represent those attributes associated with high-performing advertising campaigns as appropriate to the requirements of specific applications of the invention. In several embodiments, the identified dominant attributes are utilized to determine how a title (or any other data describing the product within an advertising creative) is built using the attributes and keywords present in the product data feed for a particular product. Product advertising campaigns including image data (and/or references to image data), the generated titles, and references to one or more landing pages can be created. Similarly, existing product advertising campaigns can be updated using the titles generated based on the dominant attributes. The product advertising campaigns can be transmitted to a search engine provider (and/or any content provider) to be displayed alongside the search engine results (or other content) provided by the search engine provider.

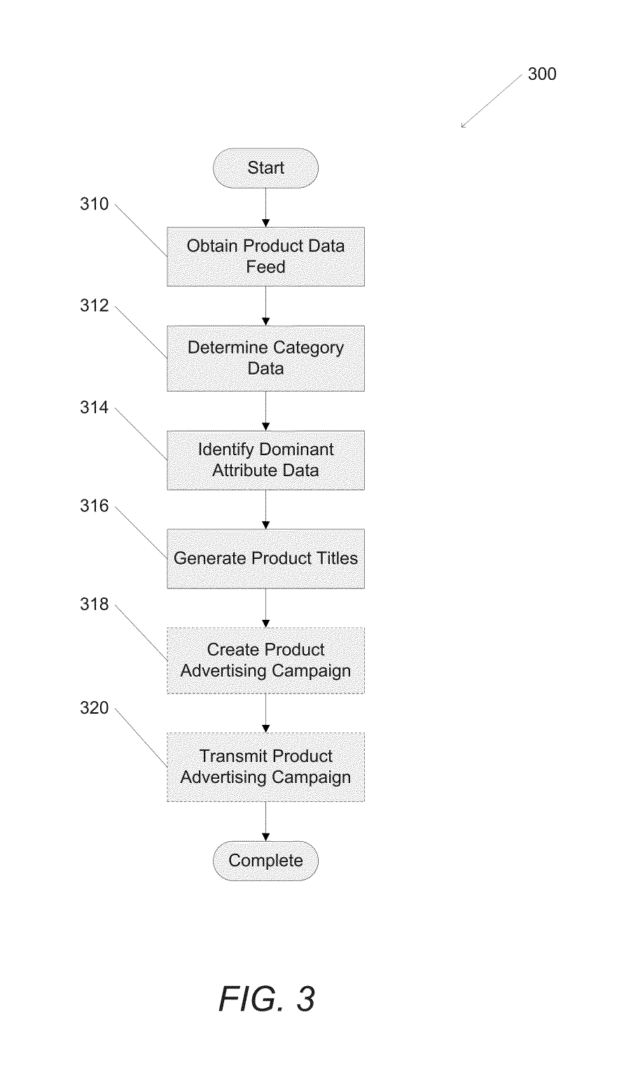

A process for creating product advertising campaigns in accordance with an embodiment of the invention is illustrated in FIG. 3. The process 300 includes obtaining (310) one or more product data feeds and determining (312) category data. Dominant attribute data is identified (314) and product titles are generated (316). In many embodiments, product advertising campaigns are created (318) and/or transmitted (320). Although specific processes for generating product titles and/or creating product advertising campaigns in accordance with embodiments of the invention are described above with respect to FIG. 3, any number of processes can be utilized as appropriate to the requirements of a specific application in accordance with embodiments of the invention. Processes for generating product titles in accordance with embodiments of the invention are described below.

### Generating Product Titles

Product advertising server systems in accordance with embodiments of the invention can generate product titles based on attributes that have been identified as high performing across a variety of advertising campaigns. In this way, the advertising creatives including the generated titles are likely to present product data corresponding to the intent of users searching for particular products. The product titles can be generated directly based on identified dominant attributes related to the product data; however, in many embodiments product title template data is generated based on the dominant attributes. In a number of embodiments, several variations of product title template data are generated in order to provide a variety of product titles within a product advertising campaign. In this way, a variety of titles can be efficiently generated to be included in product advertising campaigns targeted toward different search queries provided (i.e. intents expressed and/or information requested) by users. As described above, in several embodiments dominant attributes are determined using a taxonomy to determine attributes associated with a particular category. Based on performance information associated with the attributes for a particular category, those attributes with performance above a particular threshold, such an absolute threshold and/or relative to the other attributes associated with the category, can be selected as dominant attributes. The dominant attributes can then be ordered using any of a variety of techniques, such as by their relative performance, confidence scores, and/or into grammatically correct patterns. In a number of embodiments, additional keywords and/or other words are intermixed with the dominant attributes in order to generate a grammatically correct sentence. The ordered dominant attributes (and any additional words) can then be utilized as product title template data for the generation of a variety of titles. The titles can be generated using any of a variety of techniques, such as by utilizing keywords associated with the attributes in the product feed, using inferred keywords from the taxonomy that are associated with the dominant attributes and/or keywords provided in the product data feed, and any other technique for creating a title using words associated with the dominant attributes as appropriate to the requirements of specific applications of embodiments of the invention.

In a variety of embodiments, the words utilized in the product title are taken from metadata describing features of image data associated with the particular product for which the product title is being generated. This metadata can be provided alongside the image data (e.g. as tags or any other annotation) or be automatically generated by analyzing the image data using any of a variety of image processing techniques. In many embodiments, image processing includes identifying one or more features contained within the image data and referencing an object database to label the identified features. Similarly, particular attributes of the product can also be identified based on the image data describing the product. In this way, certain attributes of a product can be automatically identified using an image of the product and then a product advertising server system can located categories and/or attributes corresponding to the identified attributes of the product. For example, an image of a pair of jeans can be processed to identify the brand of jeans based on the back pocket and the color of the jeans. Furthermore, keywords can also be obtained using the taxonomy and these keywords can be combined with the identified category and/or dominant attributes to generate product titles describing the product. In this way, dominant attributes and/or product titles can be automatically generated based on an image of a particular product.

In a number of embodiments, the product data is included in an existing advertising campaign with pre-existing titles associated with the product data. In these embodiments, the title template data can be utilized to enhance the existing product titles. In many embodiments, the product titles are analyzed to identify keywords and/or attributes present in the product titles. Any of a variety of techniques, such as lexical analysis, semantic analysis, and keyword matching can be utilized as appropriate to the requirements of specific applications of the invention. In several embodiments, categories and/or attributes for one or more keywords in the existing product title(s) are determined using a taxonomy. The title template data can be utilized to identify additional attributes that could be included in the product titles, determine keywords that could be removed from the product titles, and/or alternative arrangements of keywords based on the dominant attributes as appropriate to the requirements of specific applications of embodiments of the invention. Enhanced product titles could then be generated based on the dominant attributes and the existing product titles. Furthermore, existing web pages and structured data associated with the products can be improved by analyzing the web page title and adding missing attributes using the dominant attributes.

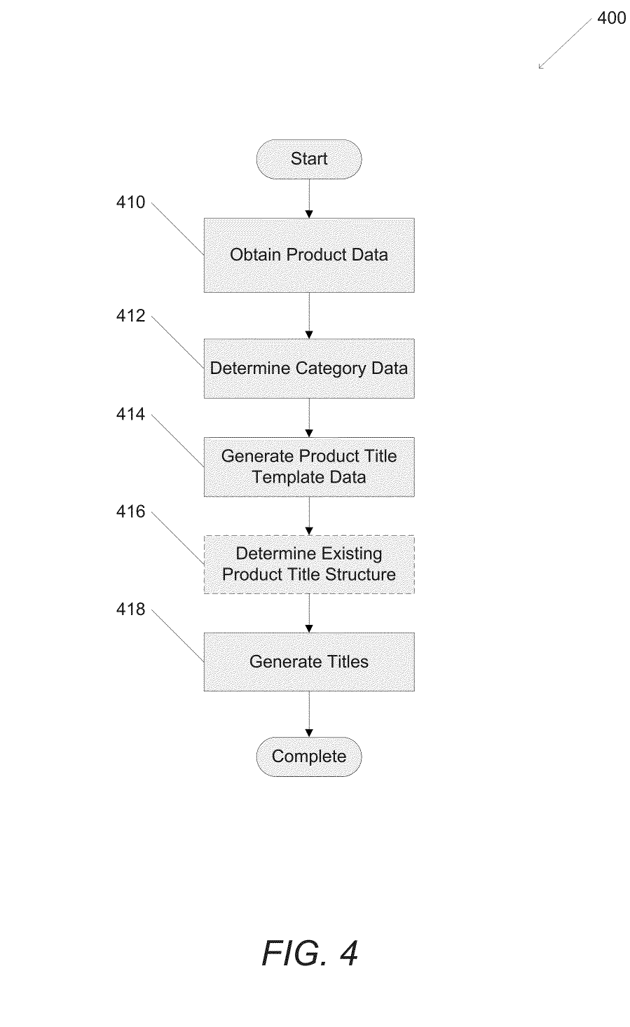

A process for generating product titles in accordance with an embodiment of the invention is illustrated in FIG. 4. The process 400 includes obtaining (410) product data and determining (412) category data. Product title template data is generated (414) and, in several embodiments, existing product title structure(s) are determined (416). Titles are generated (418). Specific processes for generating product in accordance with embodiments of the invention are discussed above with respect to FIG. 4; however, any of a variety of processes, including those that utilize alternative image processing techniques to identify and label features of image data, can be utilized in accordance with embodiments of the invention. Techniques for determining dominant attributes and generating product titles with missing attributes in accordance with embodiments of the invention are described below.

Generating Titles with Missing Attributes

In many cases, a product data feed does not include all attributes that could describe a particular product. In particular, a product data feed may not include a particular dominant attribute. When a product data feed is missing a dominant attribute contained in product title template data, a variety of techniques can be employed in order to fulfill or replace the missing dominant attributed. As described above, keywords for the dominant attribute can be inferred using a taxonomy and/or by automatically generating keywords by processing image data associated with the product. Furthermore, additional information can be requested from the entity (e.g. a product data server system) providing the product data feed.

In several embodiments, the missing dominant attribute can be eliminated and/or replaced from the product title template data. The elimination and/or replacement of a dominant attribute can be based on confidence scores associated with the dominant attributes. For example, if there are two dominant attributes with similar confidence scores, where the first dominant attribute is not present in the product data feed and the second dominant attribute is, the first dominant attribute can be excluded from the product title template data and/or the second dominant attribute can be included in the product title template data. By way of a second example, if a dominant attribute that is not present in the product data feed has a confidence score below a particular threshold, the dominant attribute can be excluded from the product title template data. In this way, accurate product titles can be generated using the available data without significantly affecting the calculated effectiveness of the generated titles and thereby the product advertising campaign.

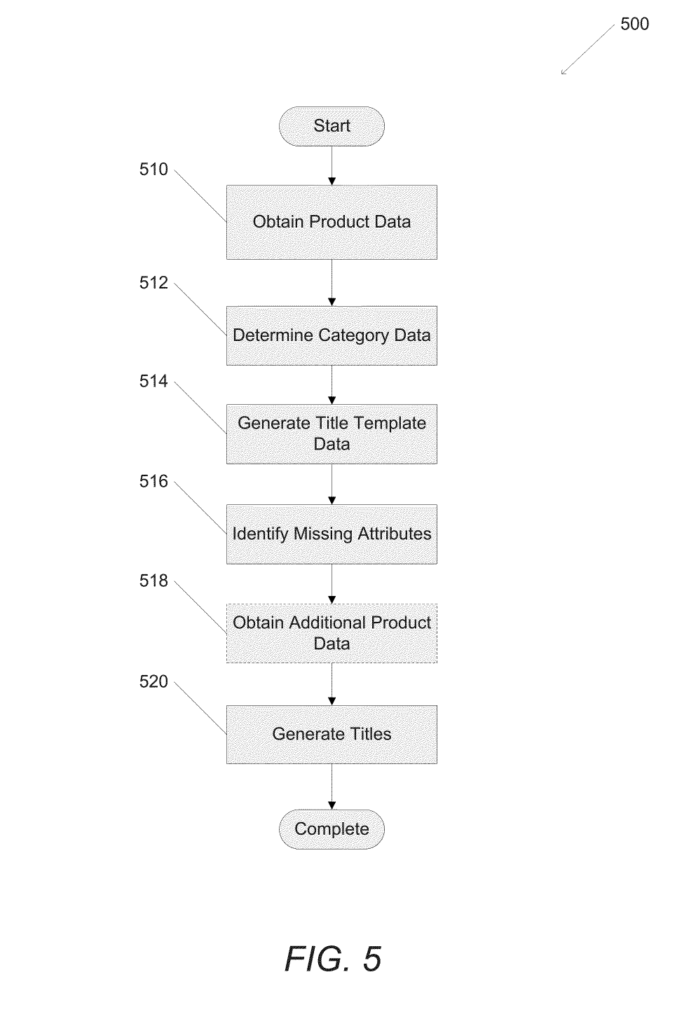

A process for generating product titles with missing attributes in accordance with an embodiment of the invention is illustrated in FIG. 5. The process 500 includes obtaining (510) product data, determining (512) category data, and generating (514) title template data. Missing attributes are identified (516) and, in several embodiments, additional product data is obtained (518). Titles are generated (520). Although specific processes for generating product titles with missing attributes in accordance with embodiments of the invention are discussed above with respect to FIG. 5, any of a variety of processes, including those that resolve missing attributes in the product data utilizing alternative techniques, can be utilized in accordance with embodiments of the invention. Methods for determining dominant attributes in accordance with embodiments of the invention are described in more detail below.

### Generating Product Title Templates

When determining categories for particular products, one or more categories within a taxonomy can be identified as relevant to the product. The categories could be totally independent, although many of the identified categories can be sub-categories of a broader parent category. Each of these categories can have a different set of dominant attributes associated with them for a particular product. Product advertising server systems can dynamically generate product title template data (and therefore product titles) based on a variety of categories associated with a particular product. In many embodiments, an expected confidence score can be determined for each category based on the identified dominant attributes for each category. In several embodiments, a single category can be utilized based on the expected confidence score. However, in a number of embodiments, the dominant attributes across several categories are utilized.

When comparing dominant attributes across categories, the dominant attributes can be aggregated into a single set of dominant attributes utilizing a variety of techniques as appropriate to the requirements of specific applications of embodiments of the invention. One such technique is exact match merging, where if dominant attributes from different categories refer to the same attribute, they are treated as a single dominant attribute. A second technique is close match merging, where if a particular number of dominant attributes match across categories, the dominant attributes from the categories are merged into a single set. The number of attributes can be based on any of a variety of metrics, such as an overall percentage of attributes matching, having attributes of a particular confidence score matching, and any other matching metric applicable to the requirements of particular applications of the invention. Additionally, those categories that have dominant attributes having confidence scores below a particular threshold can be excluded from the merging (e.g. aggregation) process. In this way, the usage of categories that may be relevant but have lower historical performance across a variety of advertising campaigns can be limited, thereby facilitating the generation of product titles having dominant attributes associated with high performing product advertising campaigns.

In a number of embodiments, only a limited number of dominant attributes can be included in a piece of product title template data. For example, there may be a length limit on the generated product titles, thereby limiting the number of attributes that can be expressed in the generated title. While it may be beneficial to generate product titles having all of the dominant attributes across the entire product advertising campaign, product advertising server systems can select particular dominant attributes that are included in most (or all) of the generated product titles. These top performing dominant attributes can be determined from the identified dominant attributes using any of a variety of criteria, such as performance data associated with the dominant attributes, the number of categories (and/or sub-categories) associated with the dominant attributes, the availability of the dominant attributes in the product data feed, and/or any other criteria (or combination thereof) as appropriate to the requirements of specific applications of embodiments of the invention. Similarly, the positioning of the dominant attributes in the product title template data can be based on similar criteria. Additionally, the relative positioning of the dominant attributes across multiple product data title templates can be convolved based on similar criteria utilizing techniques similar to those described above. Particular attributes, such as the identified top attributes, can be assigned fixed positions while the remaining dominant attributes are utilized in varying orders based on metrics, such as the above criteria, confidence scores, and/or grammatical rules as appropriate to the requirements of specific applications of the invention. In this way, a variety of product titles can be generated having a mixture of keywords corresponding to identified dominant attributes and facilitating a broad set of product titles across the product advertising campaign. Additionally, this allows for effective performance data to be generated with respect to the varying product titles; this performance data can be utilized by product advertising server systems to further refine and generate additional product titles.

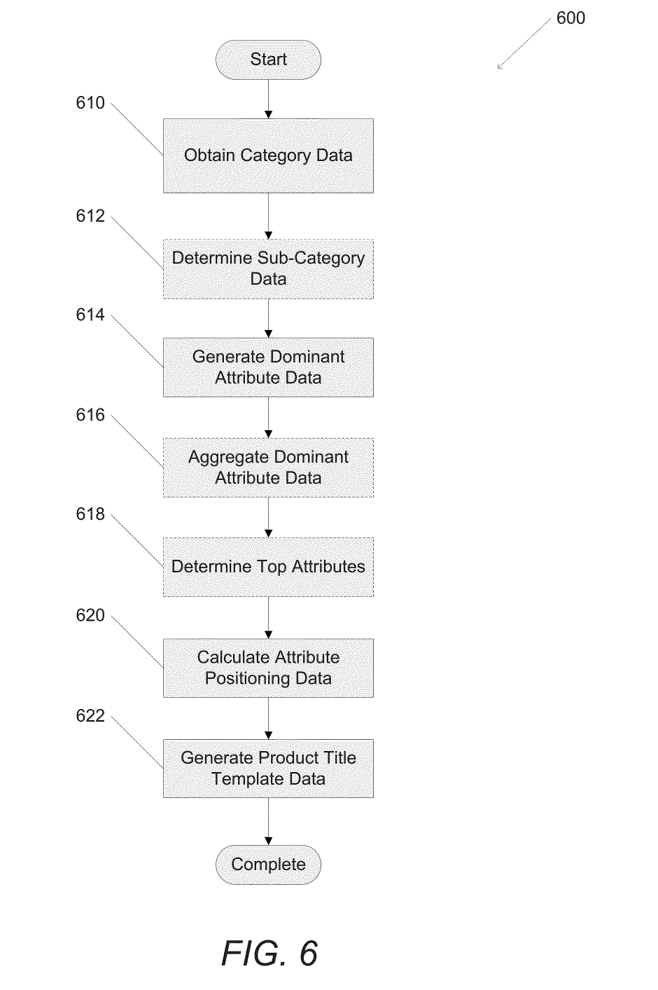

A process for generating product title template data in accordance with an embodiment of the invention is illustrated in FIG. 6. The process 600 includes obtaining (610) category data and, in many embodiments, sub-category data is determined (612). Dominant attribute data is generated (614) and, in a number of embodiments, aggregated (616). In several embodiments, top attributes are determined (618). Attribute positioning data is calculated (620) and product title template data is generated (622). While specific processes for generating product title template data in accordance with embodiments of the invention are discussed above with respect to FIG. 6, any of a variety of processes, including those that generate titles directly and those that utilize alternative techniques for determining dominant attributes across categories, can be utilized in accordance with embodiments of the invention.

### Determining Dominant Attributes

In a variety of embodiments, dominant attributes are determined based on the keywords utilized by users searching for particular products and/or descriptions of particular products. In this way, the dominant attributes for a particular product and/or category can then be utilized to better target product titles (or any other aspect of a product advertisement) to the context in which the product advertisement is to be shown. To this end, dominant attributes can be specific to particular advertising channels. For example, dominant attributes for search advertising campaigns may be different from the dominant attributes for a product listing advertising campaign. Raw data (or any other training data) can be utilized in order to identify dominant attributes. Raw data includes, but is not limited to, search queries, product catalogs, web page content, messages identifying the products taken from one or more online social networks, and any other data describing one or more pieces of product data utilizing categories, attributes, and/or keywords as appropriate to the requirements of specific applications of embodiments of the invention. In many embodiments, the raw data also includes performance data describing the performance of the raw data, such as impressions, clicks, conversions, revenue, margin data, importance, and any other performance data as appropriate to the requirements of specific applications of embodiments of the invention. Additionally, time data describing when the raw data and/or performance data was obtained and/or occurred can also be included in the raw data.

The raw data can be aggregated via any of a variety of measures. In several embodiments, the time data is utilized to aggregate the raw data and/or the performance data. The (aggregated) raw data can then be encoded in order to classify the data. The classification can be performed using any of a variety of classification sources, such as a taxonomy utilized by a product advertising server system, a classification scheme provided by a product data server system and/or a search engine provider, or any other categorization scheme as appropriate to the requirements of specific applications of embodiments of the invention. In many embodiments, the encoded data is aggregated based on the categories and/or attributes contained within the encoded data. In particular, it should be notes that the categories and/or attributes of the keywords, performance data, and or time data associated with the encoded data can be taken from one or more classification sources. In a number of embodiments, the encoded data is aggregated based on one or more pieces of performance data such as, but not limited to, impressions, clicks, conversions, click-through rate, conversion rate, revenue, margin, return on investment, and an attribute value count (e.g. a measure of the occurrence of the keyword and/or attribute within the raw data and/or encoded data). Based on the performance data and the categories, attributes, and keywords in the encoded data, the performance of the categories, attributes, and keywords can then be determined. Based on the performance of the categories, attributes, and/or keywords, the dominant attributes can then be determined. The dominant attributes can be determined relative to the attributes in the encoded data and/or determined relative to an independent threshold value. For example, the attributes in the encoded data can be sorted according to their associated performance data and the top 10 (or any other number) of attributes can be selected as the dominant attributes. By way of another example, those attributes with associated performance data exceeding a threshold value (pre-determined and/or determined dynamically) can be selected as dominant attributes. Furthermore, the number of dominant attributes can be dynamically determined based on the number of categories, attributes, and/or keywords within the raw data and/or encoded data.

In a number of embodiments, the dominant attributes are associated with one or more categories and/or advertising channels. The determined dominant attributes can then be stored in a taxonomy for use in the generation of product advertisements as appropriate to the requirements of specific applications of embodiments of the invention. It should also be noted that the dominant attributes for a particular advertising channel and/or category can change over time. In this way, processes similar to those described above can be utilized to obtain additional raw data and use the raw data to identify and update the dominant attributes based on the additional raw data.

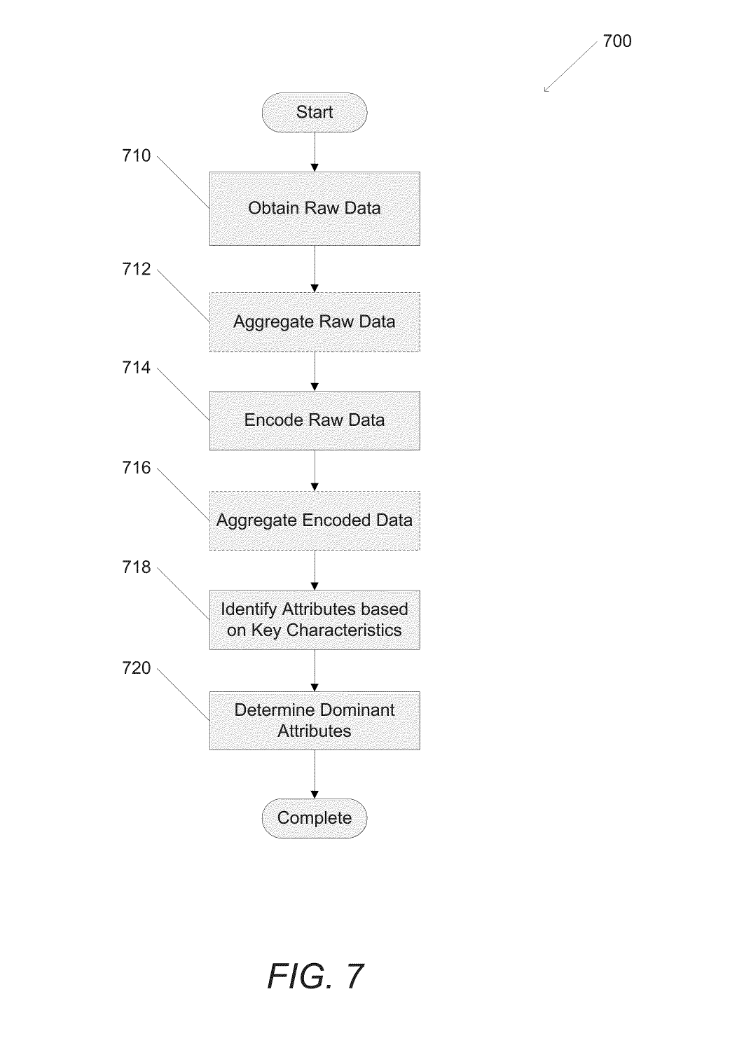

A process for determining dominant attributes in accordance with an embodiment of the invention is illustrated in FIG. 7. The process 700 includes obtaining (710) raw data and, in a variety of embodiments, aggregating (712) raw data. Raw data is encoded (714) and, in several embodiments, encoded data is aggregated (716). Attributes are identified (718) and dominant attributes are determined (720).

While specific processes for determining dominant attributes in accordance with embodiments of the invention are discussed above with respect to FIG. 7, any of a variety of processes, including those that utilize alternative techniques for determining dominant attributes across categories, can be utilized in accordance with embodiments of the invention.

Although the present invention has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A product advertising server system, comprising:
a processor; and
a memory connected to the processor and storing a product advertisement generation application;
wherein the product enhancement generation application directs the processor to:
obtain product feed data;
determine category data based on the obtained product feed data;
identify dominant attribute data based on the category data;
generate a set of product title data based on the dominate attribute data and the product feed data; and
store the generated product title data using the memory.

2. The system of claim 1, wherein the product enhancement generation application further directs the processor to:
generate a set of advertising creatives based on the generated product title data and the product feed data;
generate a product advertising campaign comprising the set of advertising creatives; and
transmit the product advertising campaign to a search engine provider.
